(19) United States
(12) Patent Application Publication
(10) Pub. No.: US 2010/0106844 A1
(43) Pub. Date: Apr. 29, 2010

(54) PROJECTOR, COMPUTER PROGRAM PRODUCT, AND NETWORK CONNECTION METHOD

(75) Inventor: Akihiko Ota, Sapporo-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/603,840

(22) Filed: Oct. 22, 2009

(30) Foreign Application Priority Data
Oct. 27, 2008 (JP) 2008-275393

(51) Int. Cl. G06F 15/16

(52) U.S. Cl. 709/228

(57) ABSTRACT

A projector includes: an interface unit that reads multiple types of network setting information stored in a portable information storing medium; an image producing unit that produces, based on the multiple types of network setting information, a network setting selection image from which a network setting used to connect the projector to a network is selected; an input unit through which receives selection information indicating which one of the network settings is selected; a communication unit that connects the projector to the network based on the selected network setting contained in the selection information; and a projection unit that projects the network setting selection image.

### CROSS-REFERENCE

The present application claims priority from Japanese Patent Application No. 2008-275393 filed on Oct. 27, 2008, which is hereby incorporated by reference in its entirety.

### BACKGROUND

When a user of a projector connects the projector to a network, the user needs to set, for example, the IP address and the information of an access point, but the setting operation requires advanced knowledge. A method for readily connecting a projector to a network is described, for example, in Japanese Patent Publication No. 2005-285091. In the method, setting information used in the projector is stored in a USB memory and the USB memory is connected to a PC (Personal Computer) to provide a communication setting.

In the method described above, the setting in one of the following communication modes is stored as the setting information in the USB memory: an ad-hoc mode in which no access point is used, an infrastructure mode in which an access point is used, and a wired LAN mode. Since the form of connection is fixed in the method, it is difficult to change the network connection setting flexibly in accordance with the actually used form of communication.

For example, when a projector is used in a conference room or a similar place, the projector is wirelessly connected to a PC in the ad-hoc mode in some cases, or the projector is wirelessly connected to multiple PCs via an access point in other cases. In this situation, the method described in Japanese Patent Publication No. 2005-285091 requires the operator not only to make a complicated connection setting but also to spend a long time to make the connection setting.

### SUMMARY

Various embodiments may provide a projector, a computer program product, and a network connection method that allow network connection to be made in a flexible manner.

A projector according to at lest one embodiment of the disclosure includes an interface unit that reads multiple types of network setting information stored in a portable information storing medium, an image producing unit that produces, based on the multiple types of network setting information, a network setting selection image from which a network setting used to connect the projector to a network can be selected, an input unit through which receives selection information indicating which one of the network settings is selected, a communication unit that connects the projector to the network based on the selected network setting contained in the selection information, and a projection unit that projects the network setting selection image.

A computer program product according to at least one embodiment of the disclosure is a computer program executed by a computer in a projector that controls an interface unit, an input unit, and a communication unit, the computer program causing a computer in the projector to carry out the functions of causing the interface unit to read multiple types of network setting information stored in a portable information storing medium, producing, based on the multiple types of network setting information, a network setting selection image from which a network setting used to connect the projector to a network can be selected, causing the input unit to receive selection information indicating which one of the network settings is selected, and causing the communication unit to connect the projector to the network based on the selected network setting contained in the selection information.

A network connection method according to at least one embodiment of the disclosure is a network connection method used with a projector including allowing the projector to read multiple types of network setting information stored in a portable information storing medium, produce, based on the multiple types of network setting information, a network setting selection image from which a network setting used to connect the projector to a network can be selected, project the network setting selection image, receive selection information indicating which one of the network settings is selected, and connect the projector to the network based on the selected network setting contained in the selection information.

According to the embodiments, since the projector can read multiple types of network setting information from the portable information storing medium and connect the projector to a network by using the selected network setting, the projector can be connected to the network in a more flexible manner.

The projector may further include a storage unit that stores the multiple types of network setting information and an updating unit that updates the network setting information stored in the storage unit.

In the configuration described above, since the projector can, for example, add a network setting by updating the network setting information, the projector can be connected to a network in a more flexible manner.

The interface unit may write the network setting information stored in the storage unit in the portable information storing medium.

In the configuration described above, since the projector can write its own network setting information in the portable information storing medium to allow other projectors to read the network setting information and to be connected to the network, the other projectors need to make no network setting. As a result, the other projectors can be more readily connected to the network.

### BRIEF DESCRIPTION OF THE DRAWINGS

Non-limiting and non-exhaustive embodiments of the present disclosure will now be described with reference to the accompanying drawings, wherein like reference numbers reference like elements.

FIG. 1 shows an example of a network used with a projector in a first embodiment.

FIG. 2 is a functional block diagram of the projector in the first embodiment.

FIG. 3 is a hardware block diagram of the projector in the first embodiment.

FIG. 4 is a flowchart showing the procedure of carrying out network setting processes in the first embodiment.

FIG. 5 shows an example of a network setting selection image in the first embodiment.

FIG. 6 is a flowchart showing the procedure of carrying out network setting information writing processes in the first embodiment.

### DESCRIPTION OF EMBODIMENTS

Embodiments applied to a projector will be described below with reference to the drawings. The following embodiments do not intend to limit at all the embodiments set forth in the claims. Further, all the configurations shown in the following embodiments are not necessarily essential to achieving the embodiments set forth in the claims.

### First Embodiment

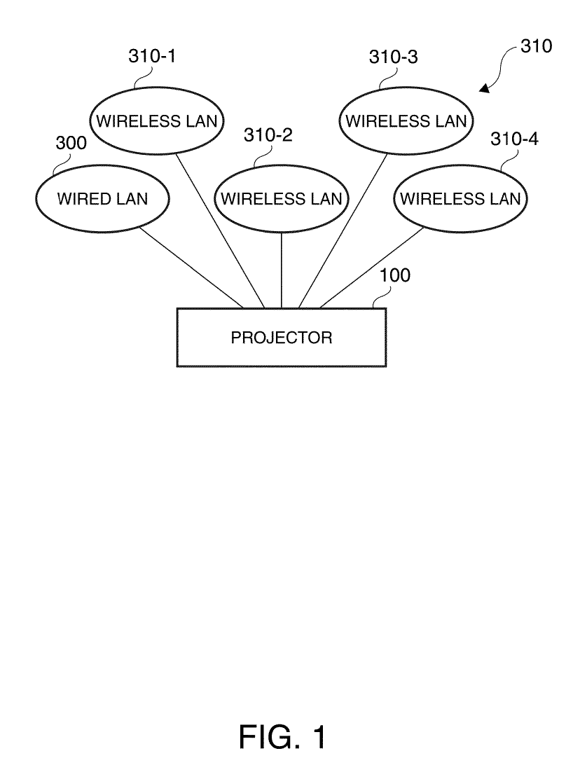

FIG. 1 shows an example of a network used with a projector 100 in a first embodiment. The projector 100 is configured to be connectable to a variety of networks, such as a wired LAN 300 and wireless LANs 310-1 to 310-4. The projector 100 is connected to any of the networks described above by reading network setting information necessary for the projector 100 to be connected to the network from a memory card or any other suitable portable information storing medium.

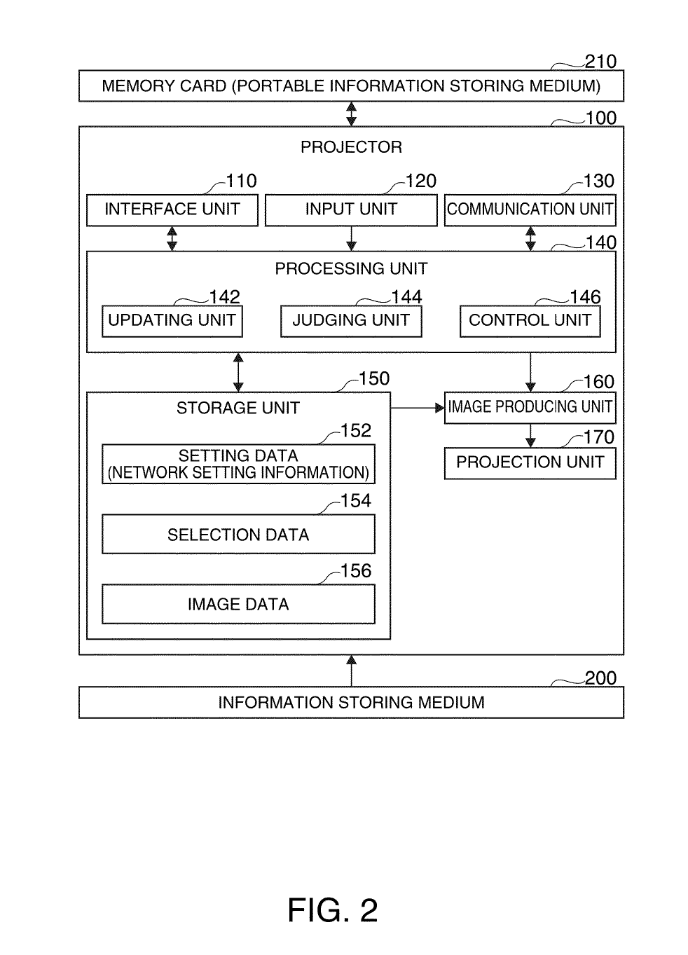

The function blocks of the projector 100 having the above function will next be described. FIG. 2 is a functional block diagram of the projector 100 in the first embodiment. The projector 100 includes an interface unit 110 through which multiple types of network setting information stored in a memory card 210 are read and written, an input unit 120 through which selection information and other information are inputted by a user, a communication unit 130 that connects the projector 100 to a network, a processing unit 140 that carries out a variety of processes, a storage unit 150 that stores a variety of data, an image producing unit 160 that produces a variety of images, and a projection unit 170 that projects the images.

The processing unit 140 includes an updating unit 142 that updates the data in the storage unit 150, a judging unit 144 that makes a variety of judgments, and a control unit 146 that performs a variety of control operations. The storage unit 150 stores setting data 152 representing network setting information, selection data 154 representing user's selection, image data 156, and other data.

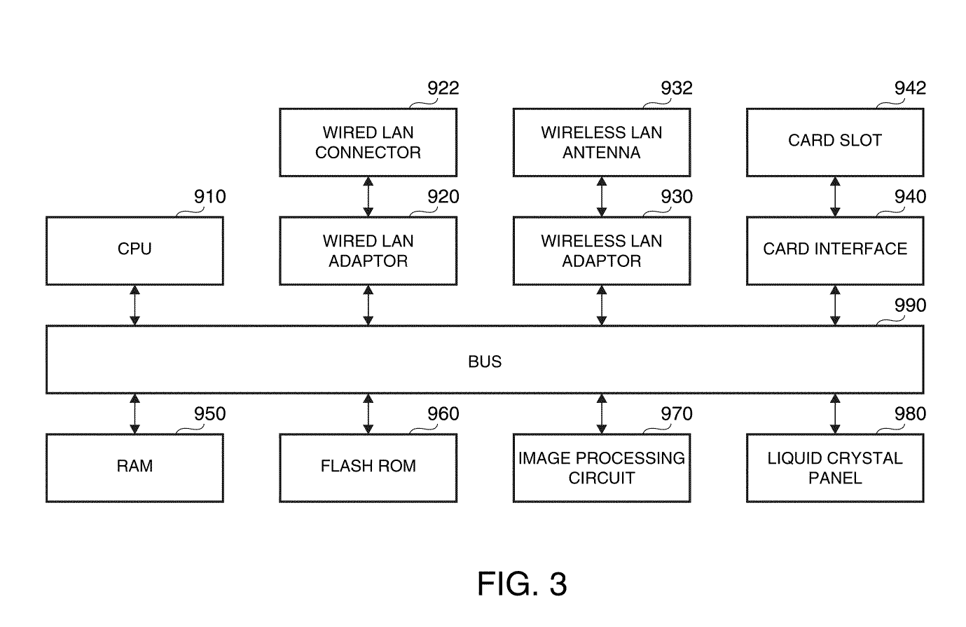

The projector 100 may implement the functions of the portions described above by using the following hardware components. FIG. 3 is a hardware block diagram of the projector 100 in the first embodiment.

For example, the units in the projector 100 may be implemented as follows: the interface unit 110 may be implemented by a card interface 940, a card slot 942, and other components; the input unit 120 may be implemented by operation buttons, a remote controller, and other components; the communication unit 130 may be implemented by a wired LAN adaptor 920, a wired LAN connector 922, a wireless LAN adaptor 930, a wireless LAN antenna 932, and other components; the processing unit 140 may be implemented by a CPU 910 and other components; the storage unit 150 may be implemented by a RAM 950, a flash ROM 960, and other components; the image producing unit 160 may be implemented by an image processing circuit 970 and other components; and the projection unit 170 may be implemented by a liquid crystal panel 980 and other components. The CPU 910 and the other components can send and receive information to and from each other via a bus 990.

Further, in the projector 100, the functions of the image producing unit 160 and other units may be implemented by reading programs stored in an information storing medium 200. Examples of the information storing medium 200 may include a CD-ROM, a DVD-ROM, a ROM, a RAM, an HDD and the like.

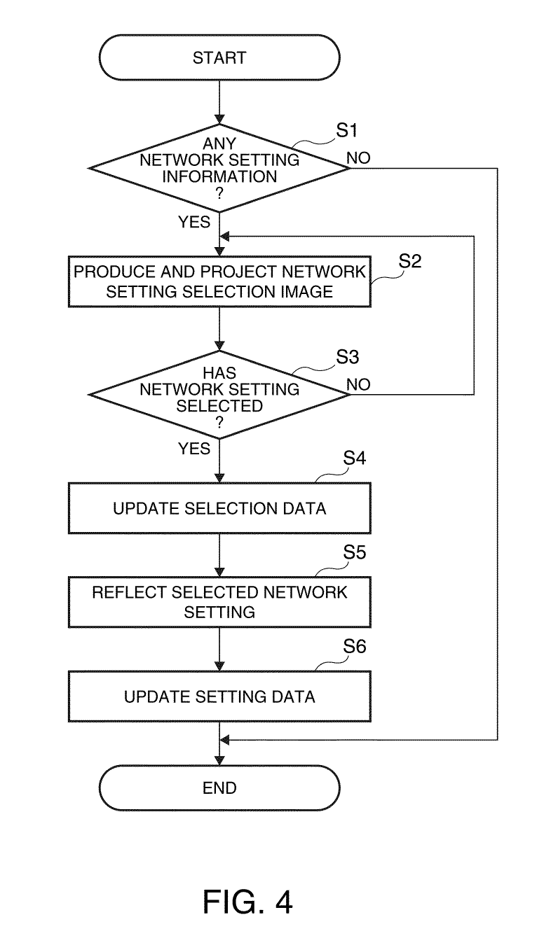

The procedure of carrying out network setting processes in the present embodiment will next be described. FIG. 4 is a flowchart showing the procedure of carrying out network setting processes in the first embodiment.

When the memory card 210 is inserted into the interface unit 110, the control unit 146 reads all network setting information in the memory card 210.

The network setting information includes the communication method, such as the ad-hoc mode; information on an access point; the communication methods used in wireless LANs (a, b, and g); and information indicating ESSID (Extended Service Set Identifier), whether DHCP is enabled or disabled, the IP address, the subnet mask, the gateway address, the security setting, the name of the projector, the password, whether the mail notification function is enabled or disabled, the name of the SMTP server, the port number, the mail address, the notification event setting, the name of the setting, the encryption method, and other parameters.

The judging unit 144 judges whether the memory card 210 has any network setting information (step S1). When the memory card 210 has network setting information, the image producing unit 160 produces a network setting selection image based on the network setting information, the setting data 152, and the image data 156, and the projection unit 170 projects the network setting selection image (step S2).

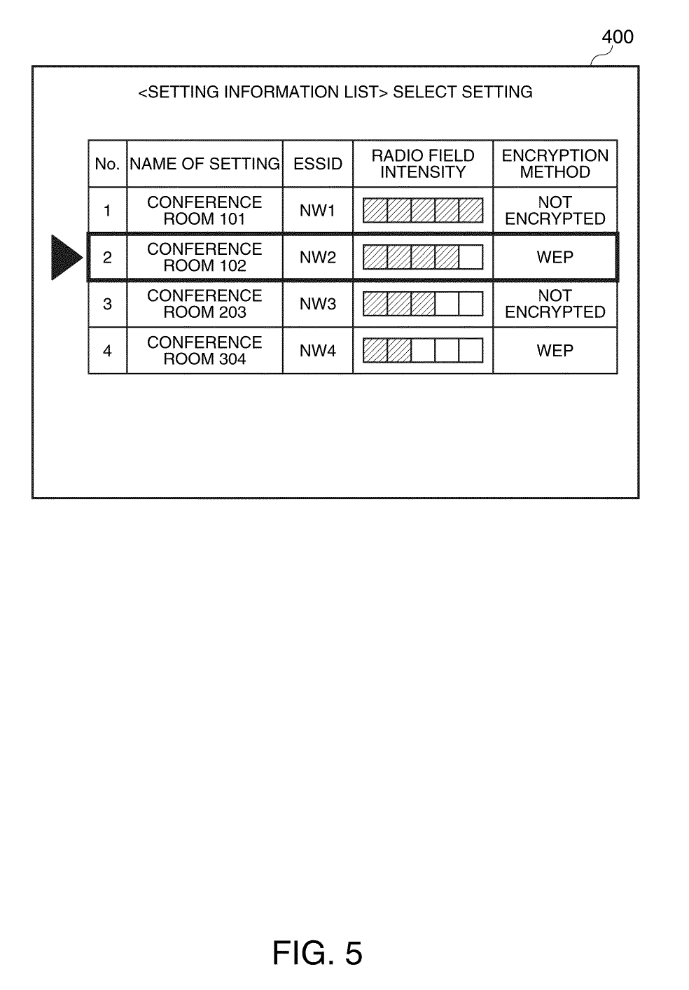

FIG. 5 shows an example of the network setting selection image 400 in the first embodiment. The network setting selection image 400 is an image from which a network setting used to connect the projector 100 to a network can be selected. For example, the network setting selection image 400 displays “No.” for identifying each setting, “Name of setting”, “ESSID” for identifying each setting, “Radio field intensity” indicative of the strength of the radio field on a scale from 1 to 5, “Encryption method”, and other parameters.

The “Name of setting”, “ESSID”, and “Encryption method” are included in each network setting information and stored as part of the setting data 152 in the storage unit 150. The “Radio field intensity” can be determined when the network setting selection image 400 is produced, etc. and the communication unit 130 performs wireless communication. The “No.” can be added when the image producing unit 160 produces the network setting selection image 400.

The judging unit 144 judges based on the information from the input unit 120 whether or not the user has selected a network setting (step S3). The input unit 120 allows the user to input selection information indicating which network setting is selected by the user.

When any network setting has been selected, the updating unit 142 updates the selection data 154 based on the selection information (step S4), and the control unit 146 instructs the communication unit 130 to reflect the selected network setting (step S5). For example, when the second network setting is selected in the network setting selection images 400, the updating unit 142 stores information that uniquely identifies the selected network setting contained in the selection information (ESSID, for example) as the selection data 154 in the storage unit 150, and the communication unit 130 connects the projector 100 to the wireless LAN 310-2, which is the second network.

The updating unit 142 updates the setting data 152 based on the network setting information read by the control unit 146 (for example, any of the following operations is carried out: new network setting information is added to the setting data 152; all the network setting information is added to the setting data 152; and only the network setting information selected by the user is added to the setting data 152) (step S6).

After the setting data 152 has been updated, the projector 100 stops projecting the network setting selection image 400 and terminates the processes.

Carrying out the processes described above allows the projector 100 to be connected to a network that the user desires, whereby the projector 100 can, for example, receive image information from a PC or any other apparatus connected to the network and project the images. The projector 100 can also reflect new network setting information in the setting data 152.

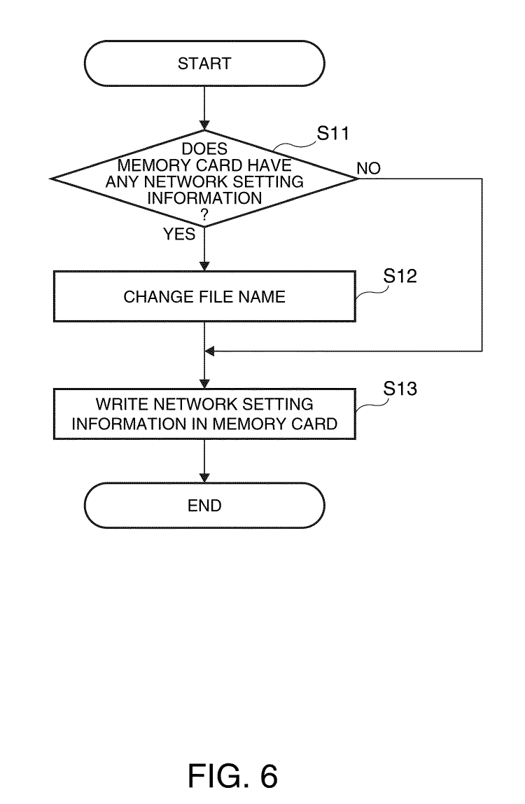

The procedure of carrying out network setting information writing processes in the projector 100 will next be described. FIG. 6 is a flowchart showing the procedure of carrying out network setting information writing processes in the first embodiment.

When the memory card 210 is inserted into the interface unit 110 and the user issues a writing instruction, the judging unit 144 judges whether the memory card 210 has existing network setting information (step S11).

When the memory card 210 has existing network setting information, the control unit 146 changes the file name of the network setting information to be newly written to a file name different from the file name of the network setting information stored in the memory card 210 (step S12).

The interface unit 110 writes the network setting information represented by the setting data 152 in the memory card 210 under the control of the control unit 146 by using the existing file name or the file name determined in the step S12 (step S13).

As described above, according to the present embodiment, since the projector 100 can read multiple types of network setting information from the memory card 210 and connect the projector 100 to a network in accordance with the network setting selected by the user, the projector 100 can be connected to the network in a more flexible manner.

Further, according to the present embodiment, since the projector 100 can measure and present the radio field intensity when the network setting selection image 400 is produced, the user can readily select a setting appropriate to the actual communication environment.

Moreover, according to the present embodiment, since the projector 100 can, for example, add a network setting by updating the setting data (network setting information) 152, the projector 100 can be connected to a network in a more flexible manner.

Further, according to the present embodiment, since the projector 100 can write its own network setting information in the memory card 210 to allow other projectors to read the network setting information and to be connected to the network, the other projectors need to make no network setting. As a result, the other projectors can be more readily connected to the network.

### Other Embodiments

The invention is not necessarily applied to the embodiment described above, but a variety of changes can be made. For example, the file name is not necessarily set as shown in FIG. 6, but the interface unit 110 may, for example, write only network setting information having an ESSID that does not present in the memory card 210.

The configuration of the projector 100 is not limited to the example shown in FIG. 2. For example, the selection data 154, the judging unit 144, the control unit 146, and other components are not essential, but the interface unit 110, the communication unit 130, and other components may have the functions of the judging unit 144, the control unit 146, and other components. For example, the communication unit 130 may connect the projector 100 to the network selected in accordance with the selection information from the input unit 120 and the setting data 152.

Further, the portable information storing medium is not limited to the memory card 210 or any other card-type information storing medium, but may be, for example, a stick-type information storing medium, such as a USB memory, or a rewritable disk-type information storing medium, such as a DVD.

The projector 100 is not limited to a (transmissive, or reflective, such as LCOS) liquid crystal projector, but may be, for example, a projector using a DMD (Digital Micromirror Device). DMD is a trademark of Texas Instruments, USA. Further, the functions of the projector 100 may be distributed to multiple apparatus (PCs and projectors, for example).

What is claimed is:

1. A projector comprising:
an interface unit that reads multiple types of network setting information stored in a portable information storing medium;
an image producing unit that produces, based on the multiple types of network setting information, a network setting selection image from which a network setting used to connect the projector to a network is selected;
an input unit through which receives selection information indicating which one of the network settings is selected;
a communication unit that connects the projector to the network based on the selected network setting contained in the selection information; and
a projection unit that projects the network setting selection image.

2. The projector according to claim 1, further comprising:
a storage unit that stores the multiple types of network setting information; and
an updating unit that updates the network setting information stored in the storage unit.

3. The projector according to claim 2,
wherein the interface unit writes at least part of the network setting information stored in the storage unit in the portable information storing medium.

4. A computer program product embodied in a computer readable medium and comprising instructions executable by computer in a projector that controls an interface unit, an input unit, and a communication unit, the instructions executable to perform the functions of:
causing the interface unit to read multiple types of network setting information stored in a portable information storing medium;
producing, based on the multiple types of network setting information, a network setting selection image from which a network setting used to connect the projector to a network is selected;
causing the input unit to receive selection information indicating which one of the network settings is selected; and
causing the communication unit to connect the projector to the network based on the selected network setting contained in the selection information.

5. A network connection method used with a projector comprising the steps of:
reading multiple types of network setting information stored in a portable information storing medium,
producing, based on the multiple types of network setting information, a network setting selection image from which a network setting used to connect the projector to a network is selected,
projecting the network setting selection image,
receiving selection information indicating which one of the network settings is selected, and
connecting the projector to the network based on the selected network setting contained in the selection information.
